(19) United States
(12) Patent Application Publication
(10) Pub. No.: US 2019/0349489 A1
(43) Pub. Date: Nov. 14, 2019

(54) OPERATION SCREEN DISPLAY DEVICE, IMAGE PROCESSING APPARATUS, AND RECORDING MEDIUM

(71) Applicant: Konica Minolta, Inc., Tokyo (JP)

(72) Inventor: Taiju INAGAKI, Toyokawa-shi (JP)

(21) Appl. No.: 16/409,009

(22) Filed: May 10, 2019

(30) Foreign Application Priority Data
May 14, 2018 (JP) 2018-93214

(51) Int. Cl. H04N 1/00; G10L 15/22; G10L 15/08; G06F 17/27

(52) U.S. Cl. CPC H04N 1/00408; G10L 15/22; G10L 15/08; G10L 2015/088; H04N 1/00403; H04N 1/00498; G06F 17/2765

(57) ABSTRACT

An operation screen display device includes a display; a keyword is retrieves from a user input and a setting of an operation condition of a job is searched out by the keyword, the setting being associated with the keyword. The operation screen display device further includes a processor that performs: judging whether or not an on-screen information piece related to the setting in an operation screen displayed on the display corresponds to the keyword; and changing the on-screen information piece related to the setting in the operation screen to an information piece corresponding to the keyword if the on-screen information piece related to the setting in the operation screen does not correspond to the keyword.

### CROSS REFERENCE TO RELATED APPLICATION

The present application claims priority under 35 U.S.C. § 119 to Japanese Patent Application No. 2018-93214 filed on May 14, 2018, including description, claims, drawings, and abstract, is incorporated herein by reference in its entirety.

### BACKGROUND

### Technological Field

The present invention relates to: an operation screen display device capable of displaying operation screens for the setting of an operation condition of a job to be executed by an image processing apparatus, for example; an image processing apparatus provided with this operation screen display device; and a recording medium.

### Description of the Related Art

Conventional multifunctional digital machines referred to as multifunction peripherals (MFP), such as image processing apparatuses, have various functions. Such an image processing apparatus is configured to display operation screens for the settings of a job on a display of its operation panel for the user to use the functions. The image processing apparatus allows the user to move between multiple operation screens by clicking a screen tab or by moving up and down a level in the screen hierarchy.

When the user needs to configure the setting of a function, he/she may be bothered by moving between screens many times to get to a target screen.

The user may be bothered even by finding a target function setting button in the screen because there are various function setting buttons, being accompanied with symbols and text strings unique to the manufacturer of the image processing apparatus.

There are image processing apparatuses using a common speech recognition technology. Such an image processing apparatus stores keywords as commands for enabling job settings and also stores the job settings; each keyword is associated with one of the job settings. When the user inputs a keyword by speech, the image processing apparatus searches for a job setting by the keyword and enables the job setting. So, the user can configure the setting of a job without the efforts to find a target operation button in the operation panel. The user may hope to input a keyword by text instead of speech.

Japanese Unexamined Patent Application Publication No. 2004-265182 suggests a technique related to the image processing apparatus. When the user inputs a natural language text for print setting into the text input box, the technique detects a condition for printing from the input text and makes the printer print a print file format image using the condition.

Japanese Unexamined Patent Application Publication No. suggests another technique related to the same. In this technique, a speech input means receives an audio signal input, a speech recognition means recognizes the audio signal input, and an association means associates each function button to be on the operation panel with a keyword. When the speech recognition means recognizes the audio signal input as any of the keywords, the technique displays a function button associated with the keyword on the operation panel.

After inputting a keyword by speech or text, the user may hope to confirm the setting via an operation screen displayed on the operation panel.

In the conventional techniques, after inputting a keyword, the user has to devote some effort to confirming the setting via an operation screen displayed on the operation panel because it is not easy to match the keyword to its corresponding text string in the operation screen. This is an unsolved problem.

For example, after inputting a speech as “zoom in at 1.2 times”, the user has to devote some effort to confirming the setting because text strings “Scale” and “120%”, instead of text strings “Zoom” and “1.2”, are displayed in the operation screen.

For another example, the user may speak English and not understand Japanese very well. After inputting a speech as “staple at upper-left and duplex” in English, the user has to devote some effort to confirming the setting because only Japanese text strings are displayed in the operation screen.

The techniques suggested by Japanese Unexamined Patent Application Publication No. 2004-265182 and No. 2007-102012 do not find a solution to the problem.

### SUMMARY

The present invention, which has been made in consideration of such a technical background as described above, is capable of allowing the user to confirm job settings easily via an operation screen after configuring the setting of an operation condition of a job by inputting a speech or text.

A first aspect of the present invention relates to an operation screen display device comprising a display, wherein a keyword is retrieved from a user input and a setting of an operation condition of a job is searched out by the keyword, the setting of the operation condition of the job being associated with the keyword, the operation screen display device further comprising a processor that performs:
judging whether or not an on-screen information piece related to setting in an operation screen displayed on the display corresponds to the keyword; and
changing the on-screen information piece related to setting in the operation screen to an information piece corresponding to the keyword if the on-screen information piece related to setting in the operation screen does not correspond to the keyword.

A second aspect of the present invention relates to a non-transitory computer-readable recording medium storing a program for execution by a computer of an operation screen display device comprising a display, wherein a keyword is retrieved from a user input and a setting of an operation condition of a job is searched out by the keyword, the setting of the operation condition of the job being associated with the keyword, the program to make the computer execute:
judging whether or not an on-screen information related to setting in an operation screen displayed on the display corresponds to the keyword; and
changing the on-screen information piece related to setting in the operation screen to an information piece corresponding to the keyword if the on-screen information piece related to setting in the operation screen does not correspond to the keyword.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 illustrates a configuration of an image processing system including an image processing apparatus provided with an operation screen display device according to a first embodiment of the present invention.

FIG. 2 is a block diagram illustrating a configuration of an image processing apparatus and a configuration of a server.

FIG. 3 is an example of a table stored on a storage device of the image processing apparatus, in which each setting is associated with a Japanese and English text string.

FIG. 4 is an example of a table stored on a storage device of the image processing apparatus, in which each setting is associated with a unit.

FIG. 5A and FIG. 5B are views for reference in describing a first embodiment of the present invention, illustrating an operation screen before and after the refreshing of the on-screen information.

FIG. 6A and FIG. 6B are views for reference in describing a second embodiment of the present invention, illustrating an operation screen before and after the refreshing of the on-screen information.

FIG. 7A, FIG. 7B and FIG. 7C are views for reference in describing a third embodiment of the present invention, illustrating an operation screen before and after the refreshing of the on-screen information.

FIG. 8 is a view for reference in describing how the user can input keywords.

FIG. 9A and FIG. 9B are views for reference in describing an example of how the user inputs a text.

FIG. 10 illustrates a configuration of an image processing system, including a terminal apparatus provided with an operation screen display device according to a fifth embodiment of the present invention.

FIG. 11A and FIG. 11B illustrate an operation screen before and after the refreshing of the on-screen information, to be displayed on the terminal apparatus of the image processing system of FIG. 10.

FIG. 12A, FIG. 12B, and FIG. 12C are views for reference in describing how the image processing apparatus synchronizes its operation screen from the terminal apparatus in the image processing system of FIG. 10.

FIG. 13A and FIG. 13B are views for reference in describing a sixth embodiment of the present invention, illustrating an operation screen before and after the refreshing of the on-screen information.

FIG. 14A and FIG. 14B are views for reference in describing a seventh embodiment of the present invention, illustrating an operation screen before and after the refreshing of the on-screen information.

FIG. 15 is a flowchart for reference in describing operations of the image processing apparatus.

### DETAILED DESCRIPTION OF EMBODIMENTS

Hereinafter, one or more embodiments of the present invention will be described with reference to the drawings. However, the scope of the invention is not limited to the disclosed embodiments.

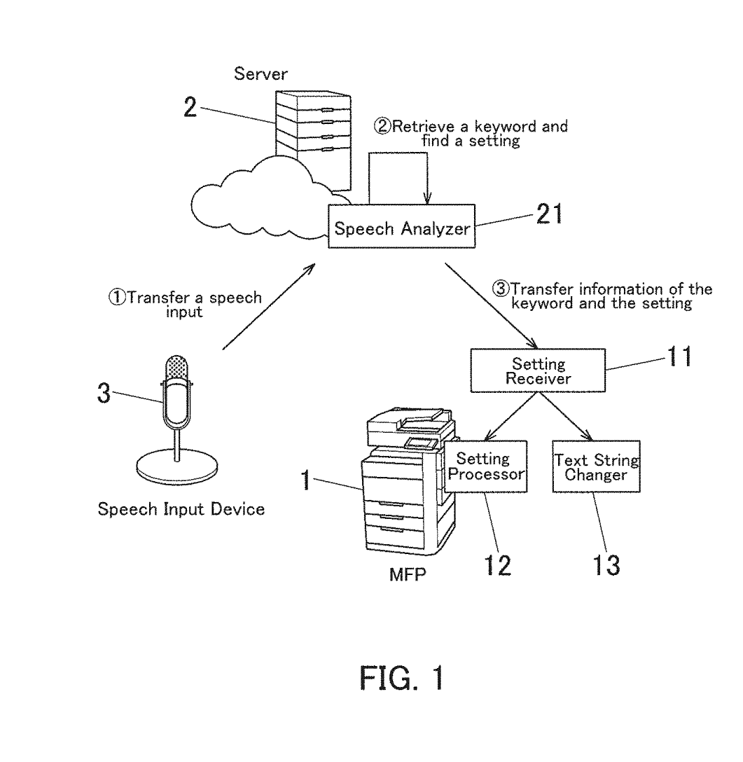

FIG. 1 illustrates a configuration of an image processing system including an image processing apparatus provided with an operation screen display device according to a first embodiment of the present invention. The image processing system is provided with: an image forming apparatus 1 as the image processing apparatus; a server 2 that is a server often referred to as “cloud”; and a speech input device 3 consisting of a microphone, for example. The image forming apparatus 1, the server 2, and the speech input device 3 are connected to each other through a network.

In the image processing system illustrated in FIG. 1, the user inputs a speech, including a keyword related to the setting of an operation condition of a job, via the speech input device 3. The speech data is transferred to the server 2 (circled number 1 in FIG. 1). Receiving the speech data, the server 2 conducts analysis and retrieves the keyword from the speech data by the speech analyzer 21 (circled number 2 in FIG. 1). The server 2 stores multiple keywords and settings of the operation conditions of a job to be executed by the image forming apparatus 1 and each keyword is associated with one of the settings. The server 2 searches for a setting by the retrieved keyword (circled number 2 in FIG. 1).

The server 2 transfers information of the keyword and the setting to the image forming apparatus 1 (circled number 3 in FIG. 1). The image forming apparatus 1 receives information of the keyword and the setting by its setting receiver 11 and configures the setting using the information by its setting processor 12. After that, the image forming apparatus 1 changes a text string related to the setting in the operation screen to a text string corresponding to the keyword by its text string changer 13. These operations will be later described more in detail.

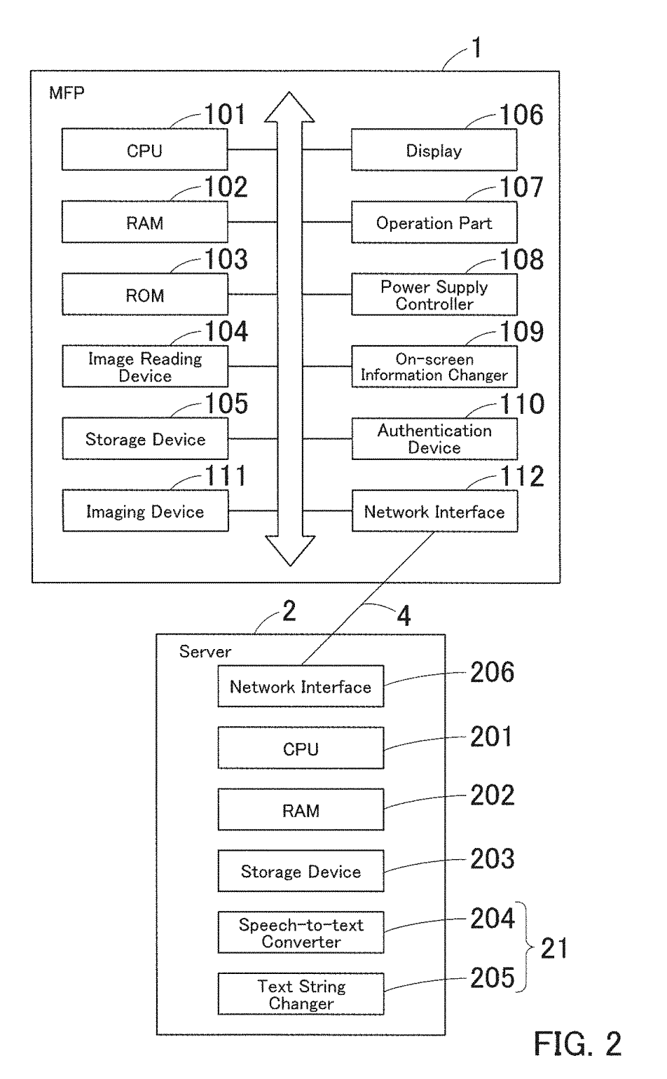

FIG. 2 is a block diagram illustrating a configuration of the image processing apparatus 1 and a configuration of the server 2. In this embodiment, an MFP i.e. a multi-functional digital machine having various functions such as a copier function, a printer function, a scanner function, and a facsimile function, as described above, is employed as the image forming apparatus 1. Hereinafter, an image forming apparatus will be also referred to as “MFP”.

As illustrated in FIG. 2, the MFP 1 is essentially provided with: a central processing unit (CPU) 101; a random access memory (RAM) 102; a read-only memory (ROM) 103; an image reading device 104; a storage device 105; a display 106; an operation part 107; a power supply controller 108; an on-screen information changer 109; an authentication device 110; an imaging device 111; and a network interface (network I/F) 112. These members are connected to each other via a system bus.

The CPU 101 controls the MFP 1 in a unified and systematic manner by executing programs stored on a recording medium such as the ROM 103. For example, the CPU 101 controls the MFP 1 in such a manner that allows the MFP 1 to execute its copier, printer, scanner, facsimile, and other functions successfully. Furthermore, in this embodiment, the CPU 101 receives information of a keyword and a setting from the server 2, configures the setting using the information, and changes a text string related to the setting in an operation screen of the display 106 to a text string corresponding to the keyword. These operations will be later described more in detail.

The RAM 102 serves as a workspace for the CPU 101 to execute a program and essentially stores the program and data to be used by the program for a short time.

The ROM 103 stores programs to be executed by the CPU 101 and other data.

The image reading device 104 is essentially provided with a scanner. The image reading device 104 obtains an image by scanning a document put on a platen and converts the obtained image to an image data format.

The storage device 105 consists of a hard disk drive, for example, and stores programs and data of various types. Specifically, in this embodiment, the storage device 105 stores different sets of image elements such as operation buttons and their designated positions depending on operation screen. The storage device 105 also stores different sets of text strings such as a setting name, a setting value, and a unit and their designated positions depending on language. These are Japanese and English text strings, for example, to be arranged in operation buttons, adjacent to operation buttons, or at other positions.

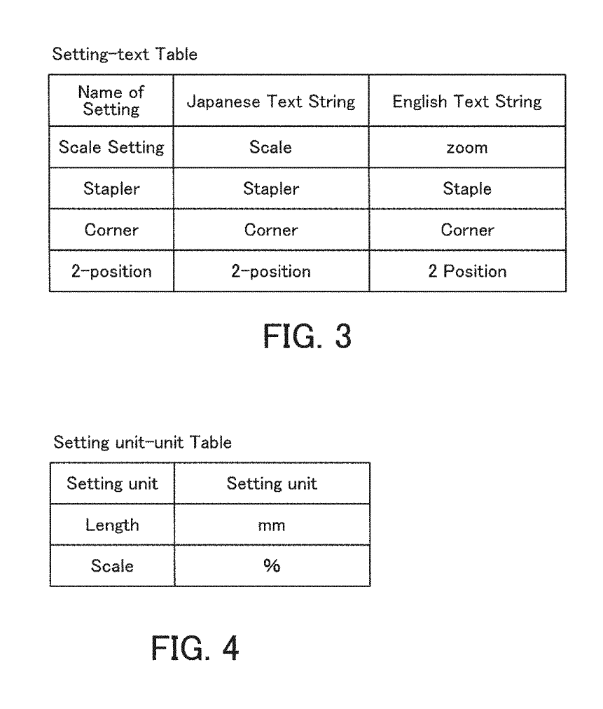

FIG. 3 is an example of a table stored on the storage device 105, in which a Japanese text string and an English text string are associated with a setting. In the setting-text table of FIG. 3, a Japanese text string and an English text string are associated with a setting name “scale setting”. When the display language is set to Japanese, the MFP 1 displays the Japanese text string in the operation screen for scale setting; when the display language is set to English, the MFP 1 displays the English text string in the operation screen for scale setting. Similarly, a Japanese text string and an English text string are associated with a setting name “stapler”, a Japanese text string and an English text string are associated with a setting name “corner”, and a Japanese text string and an English text string are associated with a setting name “2-position”.

FIG. 4 is an example of a table stored on the storage device 105, in which a unit is associated with a setting. In the setting unit-unit table of FIG. 4, a unit “mm” is associated with length and a unit “%” is associated with scale. The MFP 1 displays the unit “mm” in the operation screen for length; the MFP 1 displays the unit “%” in the operation screen for scale.

Back to FIG. 2, the display 106 consists of a liquid-crystal display device, for example, and displays messages, various operation screens, and other information; a touch-screen panel not shown in the figure is mounted on the surface of the display 106 and detects user touch events.

The operation part 107 allows the user to give a job and instructions to the MFP 1 and configure the setting of various functions of the MFP 1. The operation part 107 is essentially provided with a reset key, a start key, and a stop key that are not shown in the figure. The display 106 with the touch-screen panel is a component of the operation part 107.

The power supply controller 108 controls the power supply of the MFP 1. For example, the power supply controller 108 switches the MFP 1 to sleep mode when the MFP 1 has not been operated for a predetermined period of time.

The on-screen information changer 109 receives information of a keyword and a setting from the server 2 and changes a text string related to the setting in an operation screen of the display 106 to a text string corresponding to the keyword. The on-screen information changer 109 may be configured as one of the settings of the CPU 101.

The authentication part 110 obtains identification information of a user trying to log on and performs authentication by comparing the identification information to the proof information stored on a recording medium such as the storage device 105. Instead of the authentication part 110, an external authentication server may compare the identification information to the proof information. In this case, the authentication part 110 performs authentication by receiving a result of the authentication from the authentication server.

The imaging device 111 makes a physical copy by printing on paper image data obtained from a document by the image reading device 104 and an image formed on the basis of print data received from an external apparatus.

The network interface (network I/F) 112 serves as a transmitter-receiver means that exchanges data with the server 2 and other external apparatuses through the network 4.

The server 2 consists of a personal computer, for example. As illustrated in FIG. 2, the server 2 is essentially provided with: a CPU 201; a RAM 202; a storage device 203; a speech-to-text converter 204; a text analyzer 205; and a network interface 206.

The CPU 201 controls the server 2 in a unified and systematic manner. Specifically, in this embodiment, the CPU 201 analyzes speech data input by the user via the speech input device 3, retrieves a keyword from the speech data, and searches out a setting associated with the keyword.

The RAM 202 is a memory that serves as a workspace for the CPU 201 to execute processing.

The storage device 203 consists of a hard disk drive, for example, and stores programs and data of various types. Specifically, in this embodiment, the storage device 203 stores multiple keywords and settings for an operation condition of a job to be executed by the MFP 1 and each keyword is associated with one of the settings. For example, keywords “scale”, “enlarge”, and “reduce” are associated with scale setting and keywords “A4”, “A3”, and “B4” are associated with paper size. The storage device 203 also stores multiple non-Japanese keywords and each non-Japanese keyword is associated with one of the settings. For example, an English keyword “zoom” is associated with scale setting.

Different graphical user interfaces may be used depending on the model of MFP 1; in this case, the storage device 205 stores a setting-text table suitable for the model.

The speech-to-text converter 204 converts speech data, which is input by the user via the speech input device 3, to text form. The text analyzer 205 retrieves a keyword from the obtained text and finds a setting associated with the retrieved keyword by searching the storage device 205. The speech analyzer 21 shown in FIG. 1 is composed of the speech-to-text converter 204 and the text analyzer 205. The speech-to-text converter 204 and the text analyzer 205 are designed as one of the functions of the CPU 201.

The speech-to-text converter 204 and the text analyzer 205 also have the function of language analysis. The speech-to-text converter 204 identifies the language of a user speech input and converts the speech data to text form; and the text analyzer 205 retrieves a keyword from the obtained text and searches out a setting associated with the retrieved keyword. For example, when the user inputs an English speech as “zoom in at 1.5 times”, the text analyzer 205 retrieves keywords “1.5”, “times”, and “zoom” and searches out a setting associated with the keyword “zoom”, which is scale setting.

The network interface 206 serves as a communication means that exchanges data with the MFP 1, the speech input device 3, and other external apparatuses through the network 4.

Hereinafter, operations of the image processing system illustrated in FIG. 1 will be described.

### First Embodiment

The user inputs a speech as “zoom in at 1.2 times” in Japanese via the speech input device 3. The input speech data is transferred to the server 2 and the speech-to-text converter 204 of the server 2 converts it to text form. The text analyzer 205 of the server 2 retrieves keywords “zoom”, “1.2”, and “times” from the text data and finds a setting associated with these keywords, which is the setting name “scale setting”, by searching the storage device 205. To the MFP 1, the server 2 transfers information of the keywords and the setting, which is “zoom”, “1.2”, “times”, and “scale setting”.

Receiving the information, the MFP 1 examines text strings related to the setting name “scale setting” in the operation screen; in this example, these text strings are “Scale” and a unit “%”. The MFP 1 then judges whether or not these text strings related to “scale setting” in the operation screen correspond to the keywords “zoom” and “times”. Since they do not correspond to the keywords in this example, the MFP 1 changes the text strings from “Scale”, “%”, and “100” to “Zoom”, “times”, and “1.2”, respectively. After that, the MFP 1 refreshes the on-screen information on the display 106.

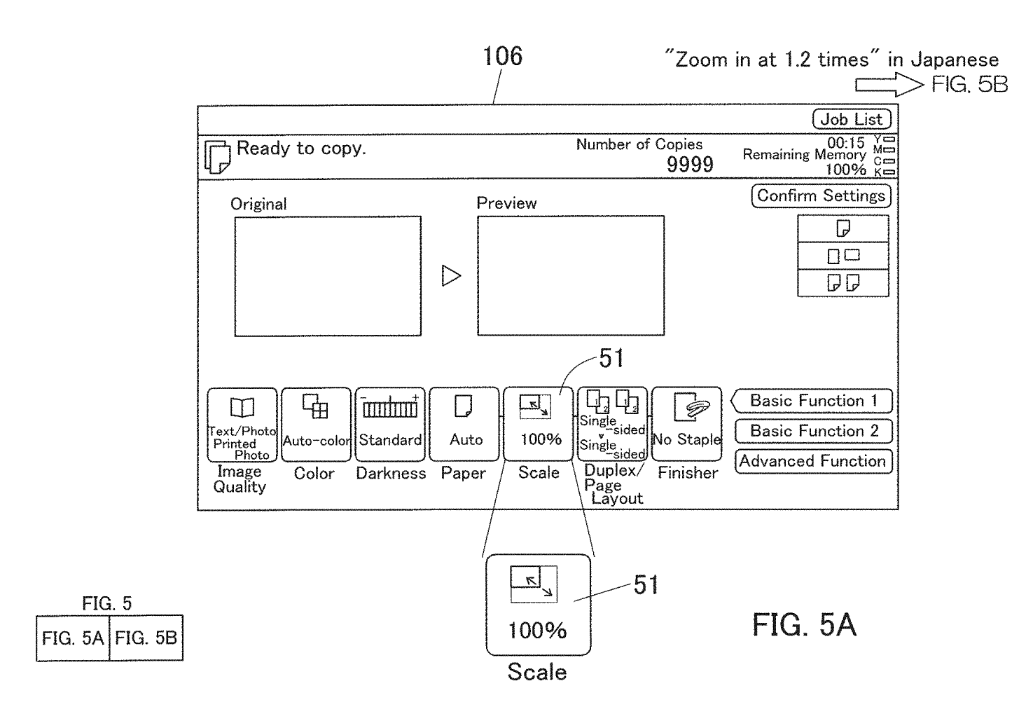

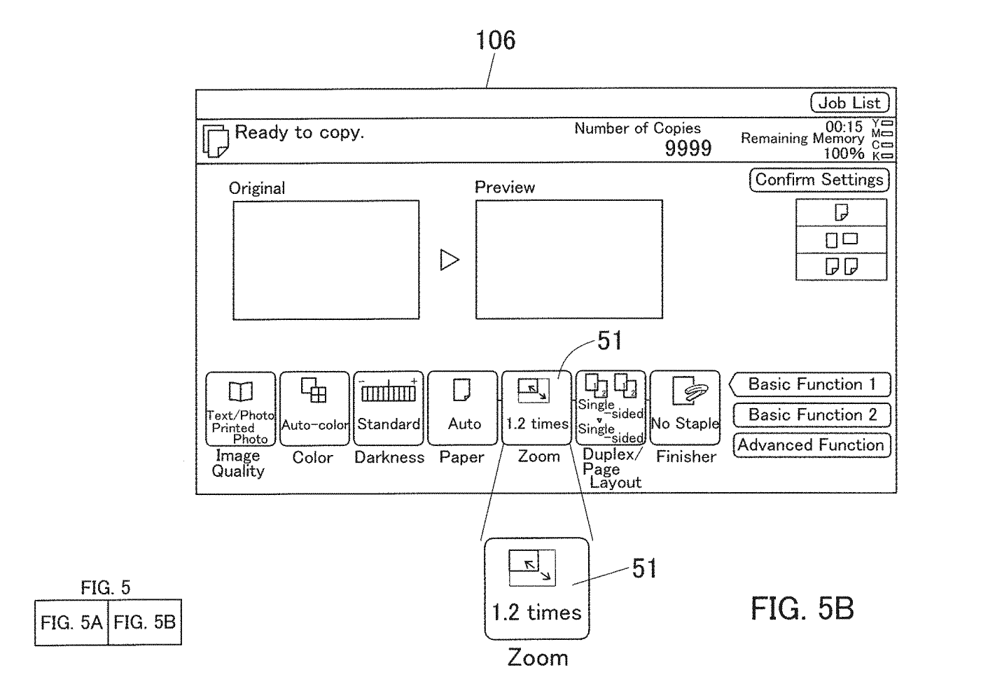

FIG. 5A and FIG. 5B illustrate an operation screen before and after the refreshing of the on-screen information. In each figure, an affected function setting button is enlarged for a better visibility. Referring to FIG. 5A, before the user inputs a speech, a scale setting button 51 has text strings “Scale” and “100%”. Referring to FIG. 5B, after the refreshing of the on-screen information, the scale setting button 51 has text strings “zoom” and “1.2 times”. These text strings correspond to spoken keywords input by the user. After the refreshing of the on-screen information, the user can confirm the setting easily via the operation screen since these text strings correspond to the keywords input by the user.

When the user inputs a speech as “start job” via the speech input device 3 or presses the start button on the MFP 1 after confirming the setting, the MFP 1 starts running a job using the setting.

### Second Embodiment

In this embodiment, when the display language is set to Japanese and the user inputs a speech in a non-Japanese language, the MFP 1 is configured to change the related text strings in the operation screen.

For example, the user inputs a speech as “zoom in at 1.5 times” in English via the speech input device 3. The input speech data is transferred to the server 2 and the speech-to-text converter 204 of the server 2 converts it to text form. The text analyzer 205 of the server 2 retrieves keywords “zoom”, “1.5”, and “times” from the text data and finds a setting associated with these keywords, which is the setting name “scale setting”, by searching the storage device 205. To the MFP 1, the server 2 transfers information of the keywords and the setting, which is “zoom”, “1.5”, “times”, and “scale setting”.

Receiving the information, the MFP 1 examines text strings related to the setting name “scale setting” in the operation screen; in this example, these text strings are “Scale” and a unit “%”. The MFP 1 then judges whether or not the text strings related to “scale setting” in the operation screen correspond to the keywords “zoom” and “times”. Since they do not correspond to the keywords, the MFP 1 changes the text strings from “Scale”, “%”, and “100” to “Zoom”, “times”, and “1.5”, respectively. After that, the MFP 1 refreshes the on-screen information on the display 106. Furthermore, the MFP 1 identifies the language of the keywords as English for their alphabetical characters and switches the display language from Japanese to English. This means, not only the text strings “zoom” and “times” but the entire on-screen information switches to English. This switch to English is reflected to all operation screens.

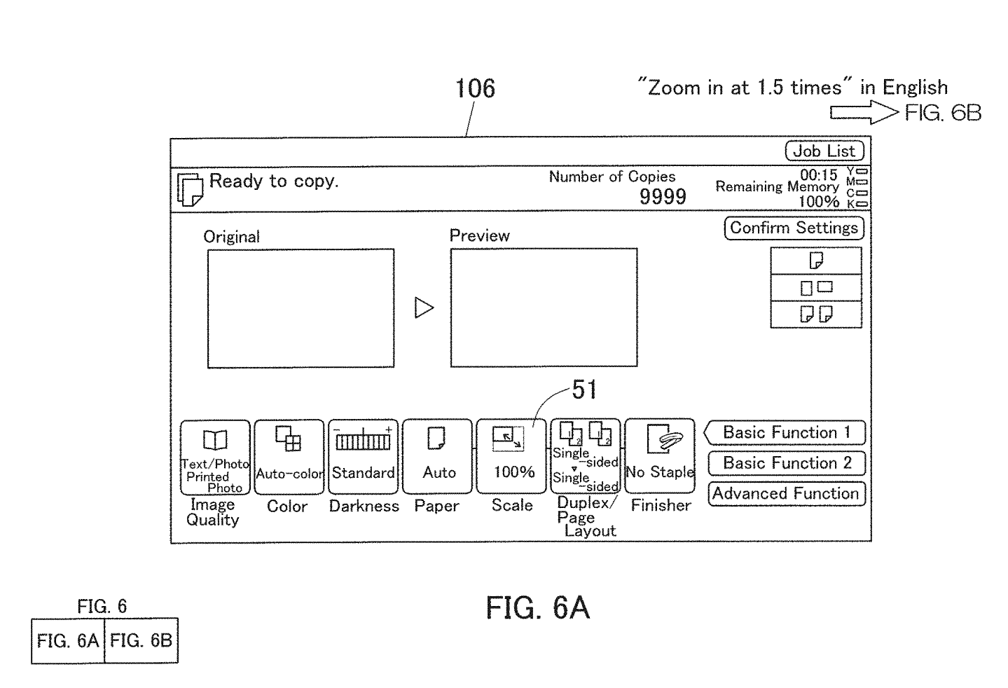

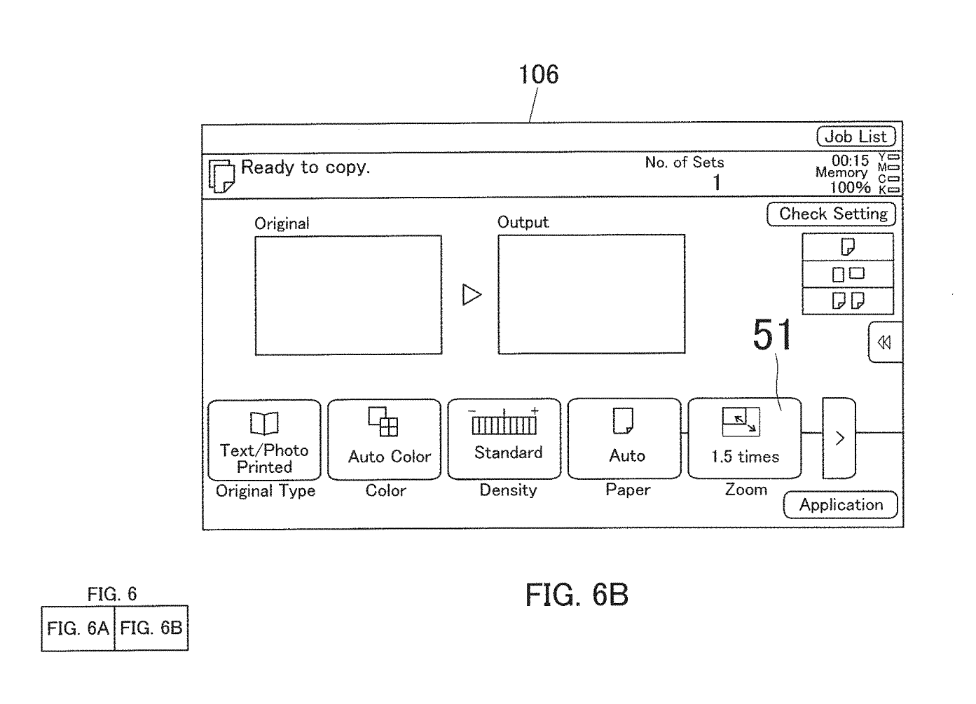

FIG. 6A and FIG. 6B illustrate an operation screen before and after the refreshing of the on-screen information. Referring to FIG. 6A, before the refreshing of the on-screen information, all text strings are Japanese and the scale setting button 51 has text strings “Scale” and “100%” in Japanese. Referring to FIG. 6B, after the refreshing of the on-screen information, all text strings are English and the scale setting button 51 has text strings “zoom” and “1.5 times” in English. These text strings correspond to spoken keywords input by the user. After the refreshing of the on-screen information, the user can confirm the setting easily via the operation screen since these text strings correspond to the keywords input by the user.

### Third Embodiment

In this embodiment, the MFP 1 is configured to change text strings related to the setting in the operation screen, corresponding to the keywords. Similarly, the MFP 1 is also configured to change another text string related to the same setting, and/or another text string related to the same unit.

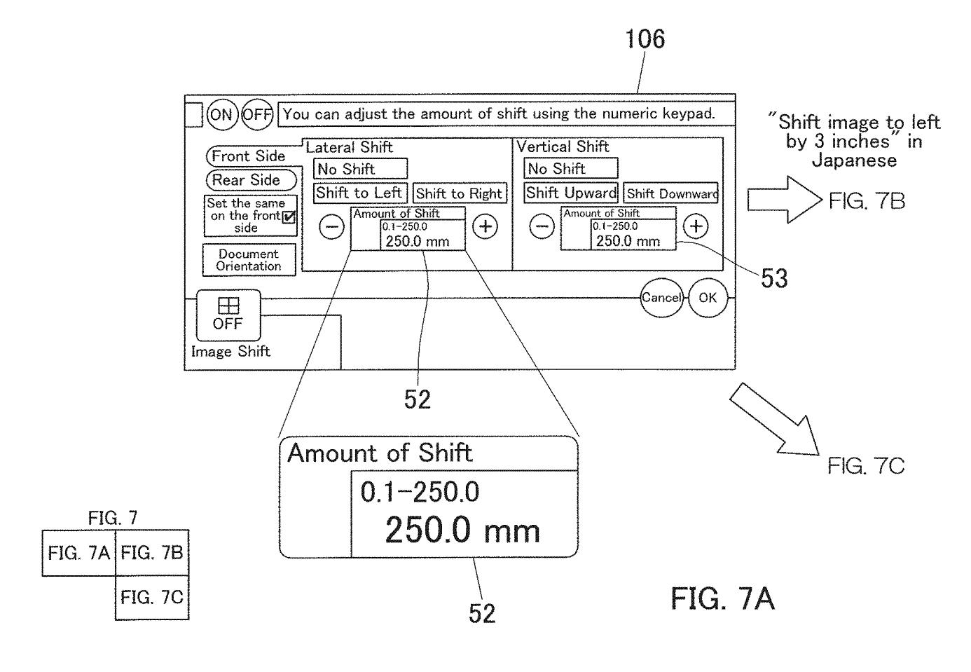

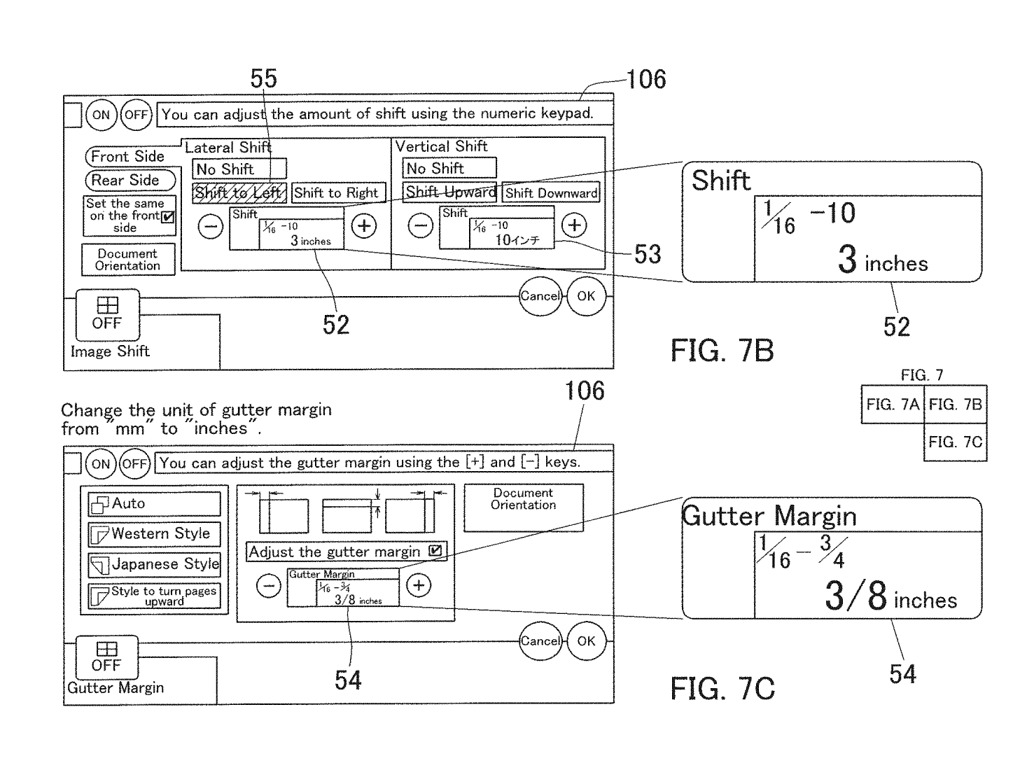

For example, while an operation screen for shift setting is displayed on the display 106, as illustrated in FIG. 7A, the user inputs a speech as “shift image to left by 3 inches” via the speech input device 3. The text-to-speech converter 204 of the server 2 converts the speech data to text form. The text analyzer 205 retrieves keywords “shift”, “3”, “inches”, and “left” from the text data and finds a setting associated with these keywords, which is the setting name “shift setting”, by searching the storage device 205. To the MFP 1, the server 2 transfers information of the keywords and the setting, which is “shift”, “3”, “inches”, “left”, and “shift setting”.

Receiving the information, the MFP 1 examines text strings related to the setting name “shift setting” in the operation screen. These text strings are “amount of shift” and a unit “mm”. The MFP 1 judges whether or not the text strings related to “shift setting” in the operation screen correspond to the keywords. Since they do not correspond to the keywords in this example, the MFP 1 changes the text strings from “Amount of Shift”, “mm”, and “250.0” to “Shift”, “inches”, and “3”, respectively. Then the MFP 1 refreshes the on-screen information on the display 106.

Referring to FIG. 7A, before the refreshing of the on-screen information, a horizontal shift value input field 52 has text strings “Amount of Shift”, “0.1-250.0”, and “250.0 mm”. Referring to FIG. 7B, after the refreshing of the on-screen information, a shift-to-left button 55 is on (as indicated by hatching in this figure) and the horizontal shift value input field 52 has text strings “Shift”, “ 1/16-10”, and “3 inches”. These text strings correspond to the spoken keywords input by the user. To convert a mm value to an inch value, it only should be multiplied by 0.0394.

Similarly, a text string related to another setting, corresponding to the name “amount of shift”, and/or a text string related to another setting, corresponding to the unit “mm”, is also changed. Referring to FIG. 7A, before the refreshing of the on-screen information, a vertical shift value input field 53 has text strings “Amount of Shift”, “0.1-250.0”, and “250.0 mm”. Referring to FIG. 7B, after the refreshing of the on-screen information, the vertical shift value input field 53 has text strings “Shift”, “ 1/16-10”, and “10 inches”.

After the refreshing of the on-screen information, the user can move to an operation screen for gutter margin setting as illustrated in FIG. 7C. Gutter margin setting also uses millimeter. In this operation screen, a gutter margin value input field 54 has an inch value with the text string “inches” instead of a mm value with the text string “mm”.

The MFP 1 may change text strings related to gutter margin setting at the time of changing text strings related to shift setting or when the user moves to the operation screen for gutter margin setting.

As described above, the MFP 1 changes text strings related to a setting in the operation screen, corresponding to a setting name and a unit. Similarly, the MFP 1 also changes another text string related to the same setting, and/or another text string related to the same unit. With this configuration, the user can confirm the setting and also configure the setting easily via the operation screen.

### Fourth Embodiment

In this embodiment, the user can input a text as well as a speech.

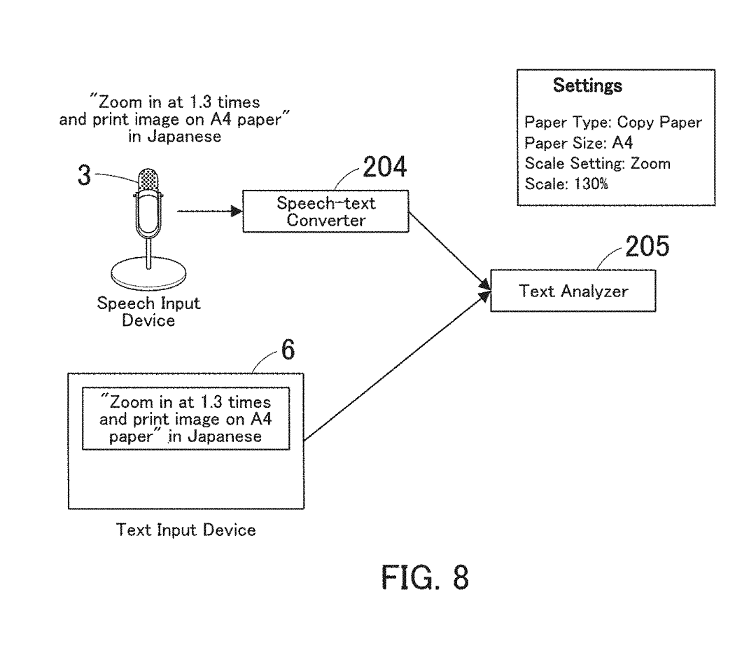

In the first, second, and third embodiments, the user inputs a speech as “zoom in at 1.3 times and print on A4 paper” via the speech input device 3, for example, as illustrated in FIG. 8. The speech-to-text converter 204 of the server 2 converts the speech data to text form. The text analyzer 205 of the server 2 retrieves keywords from the text data and searches out a setting associated with these keywords.

In this embodiment, the user also can input a text as “zoom in at 1.3 times and print on A4 paper” via a text input device 6. In this case, the text input device 6 transfers the text data to the server 2. Receiving the text data, the text analyzer 205 of the server 2 conducts analysis and retrieves keywords from the text data. The text analyzer 205 also searches out settings associated with the keywords. The keywords are “Copy Paper”, “A4”, “Zoom”, and “130%” and the settings are “Paper Type”, “Paper Size”, “Scale Setting”, and “Scale”, for example. This configuration is convenient because the user can choose a desirable input method according to the circumstances.

The text input device 6 is a terminal apparatus such as a tablet computer, a smartphone, a desktop computer, or a laptop computer.

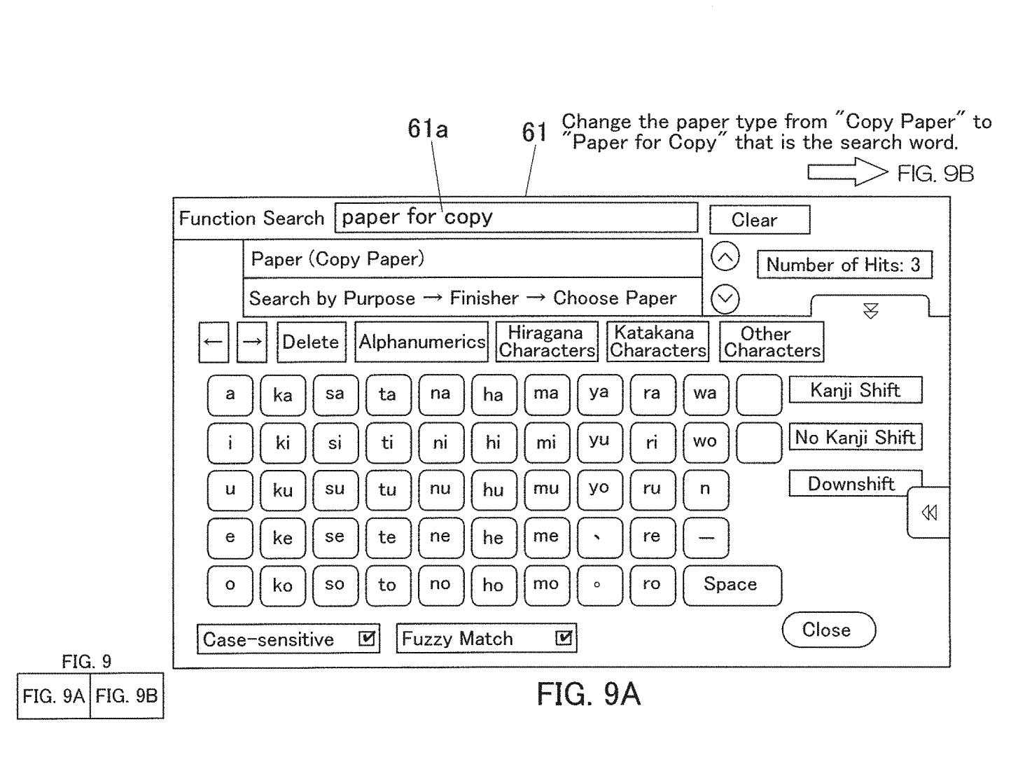

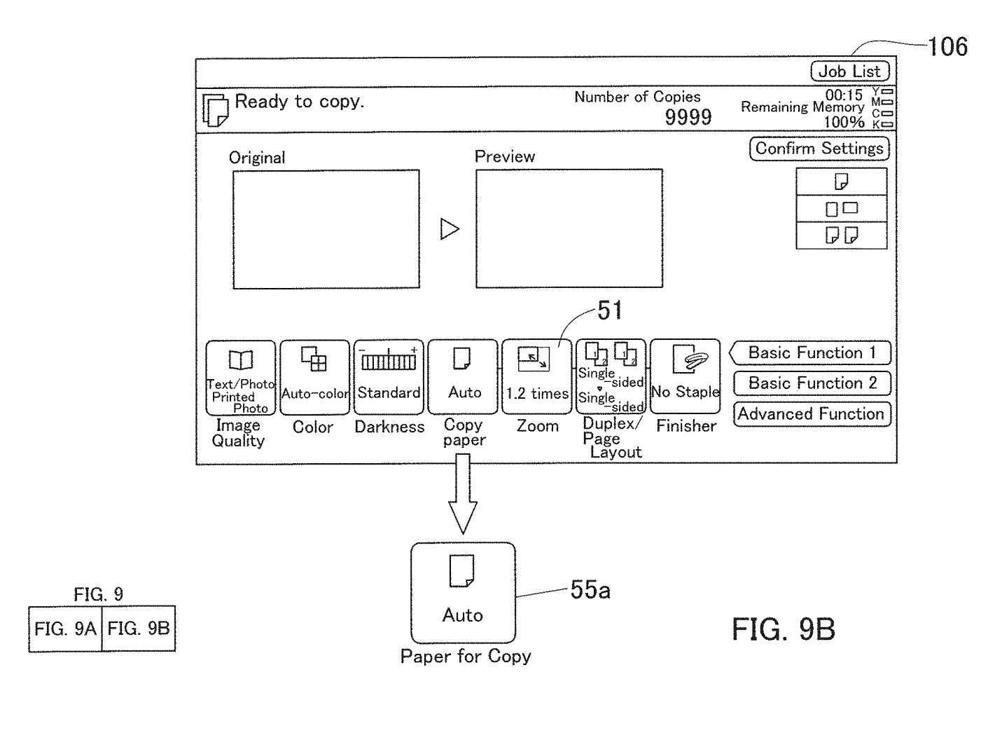

FIG. 9A illustrates a help screen 61 as an operation screen for text input. The server 2 may analyze text data input from a search box 61a of the help screen 61, retrieve keywords from the text data, and searches out a setting. Before text input, a paper setting button 55 in an operation screen displayed on the display 106 of the MFP 1 has a text string “Copy Paper”. Referring to FIG. 9A, the user inputs a search word “paper for copy” in the search box 61a of the help screen 61. Referring to FIG. 9B, after the refreshing of the on-screen information, a paper setting button 55a, which is an enlarged view of the paper setting button 55, has a text string “Paper for Copy” instead of “Copy Paper”.

With this configuration, the user can input a text easily via the help screen 61.

### Fifth Embodiment

In this embodiment, instead of the MFP 1, a terminal apparatus such as a tablet computer, a smartphone, a desktop computer, or a laptop computer is configured to display an operation screen on its display with that of the MFP 1 by a printer driver or another application.

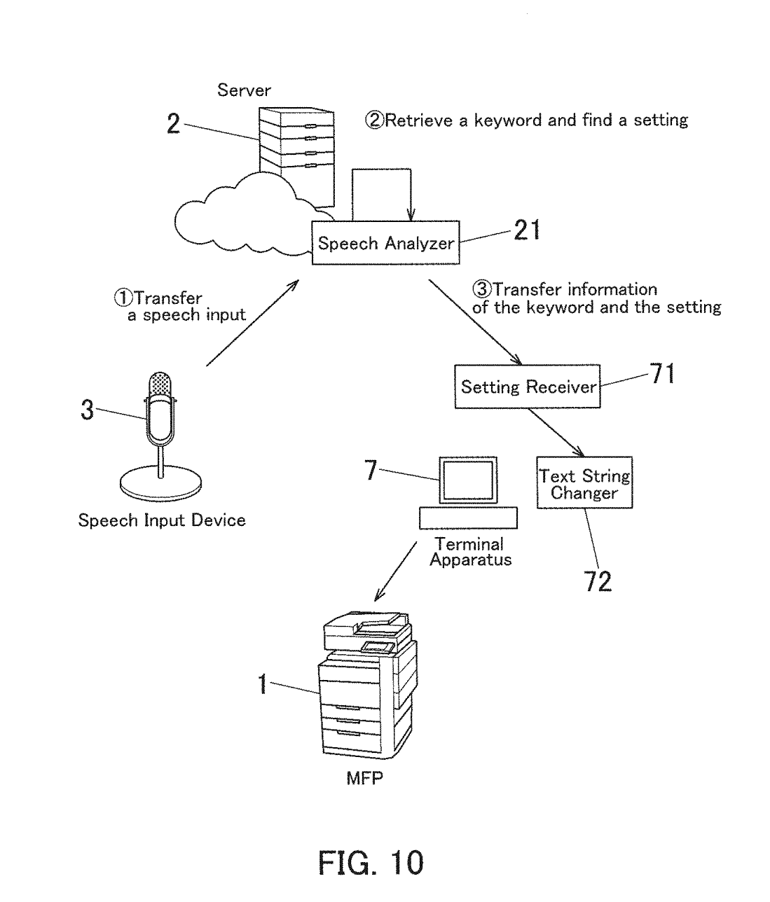

FIG. 10 illustrates an image processing system including a terminal apparatus 7. The difference from the image processing system of FIG. 1 is that the terminal apparatus 7 is employed in place of the MFP 1. This image processing system has members with the same codes as those of the image processing system of FIG. 1 to mean the members are already defined above, avoiding lengthy repetition in the description.

The terminal apparatus 7 is allowed to communicate with the server 2 and the MFP 1 through the network. As the MFP 1 of FIG. 1 does, the terminal apparatus 7 receives information of a keyword and a setting from the server 2 by its setting receiver 71. Furthermore, the terminal apparatus 7 changes a text string related to the setting in the operation screen to a text string corresponding to the keyword by its text string changer 72.

For example, the user inputs a speech as “use A4 copy paper” via the speech input device 3. The server 2 converts the speech data to text form, retrieves keywords “copy paper” and “A4” from the text data, and searches out settings “Paper Type” and “Paper Size” associated with the keywords “copy paper” and “A4”, respectively. The server 2 then transfers information of the keywords and the settings to the terminal apparatus 7.

The terminal apparatus 7 judges whether or not the text strings related to the settings “Paper Type” and “Paper Size” in the operation screen correspond to the keywords “copy paper” and “A4”, respectively.

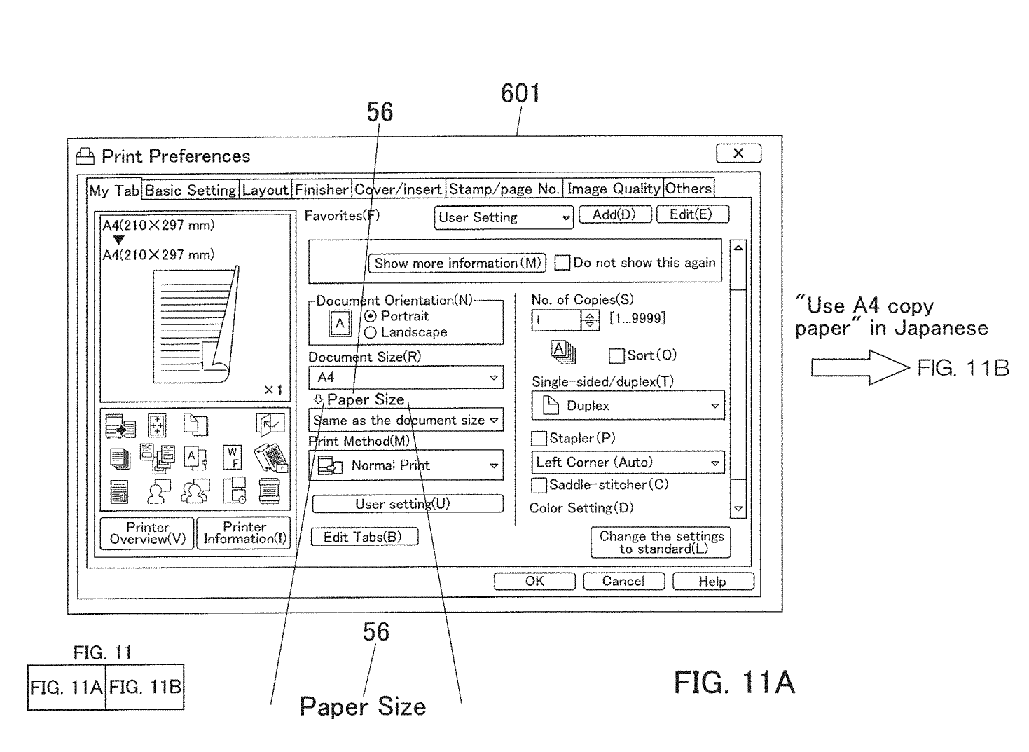

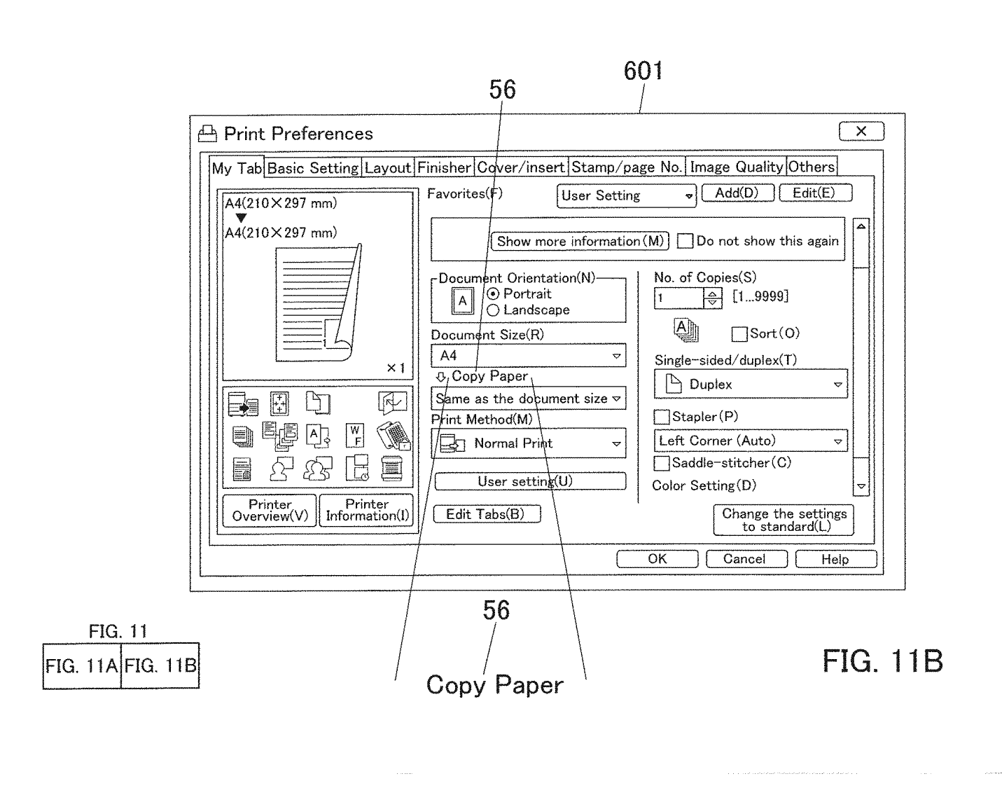

FIG. 11A illustrates an operation screen before the refreshing of the on-screen information, to be displayed on a display 601 of the terminal apparatus 7 by a printer driver or another application. In this operation screen, a paper size setting box 56 has a text string “Paper Size” as referred to a view enlarged for a better visibility. Obviously, this text string does not correspond to the keyword “copy paper”.

So, the terminal apparatus 7 changes the text string from “Paper Size” to “Copy Paper”, as illustrated in FIG. 11B.

As described above, the terminal apparatus 7 displays an operation screen on its display 601 with that of the MFP 1, and changes text strings related to a setting in the operation screen to text strings corresponding to keywords input by the user. With this configuration, the user can confirm the setting easily via the operation screen of the terminal apparatus 7.

Furthermore, the MFP 1 may synchronize an operation screen on the display 106 with that of the terminal apparatus 7. In this case, when the user starts a job, the terminal apparatus 7 may transmit to the MFP 1 a job including a keyword and a setting or a PJL command including a text string corresponding to the keyword, by a printer driver or another application. Alternatively, the terminal apparatus 7 may make a call to an application programming interface (API) of the MFP 1. Yet alternatively, the server 2 stores a keyword and a setting, allowing the MFP 1 to access and download.

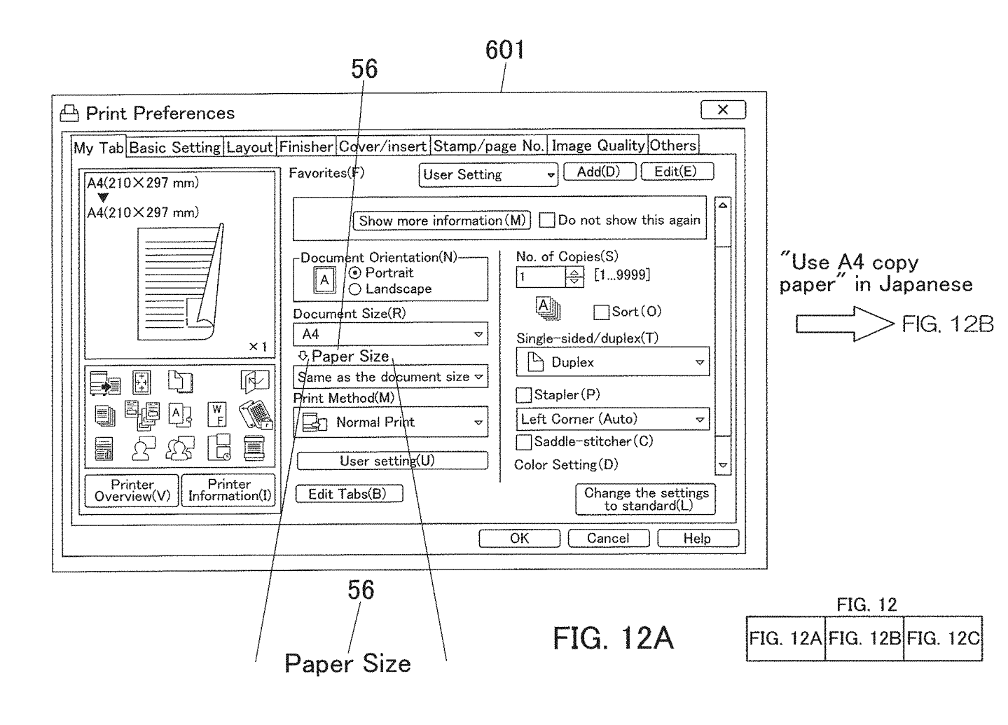

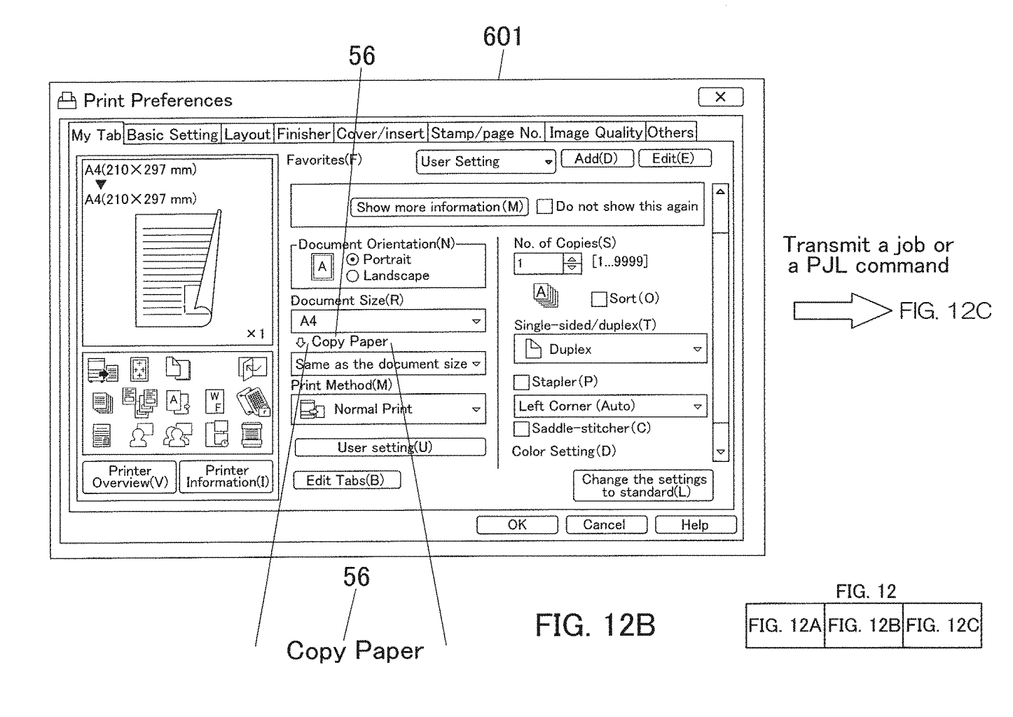

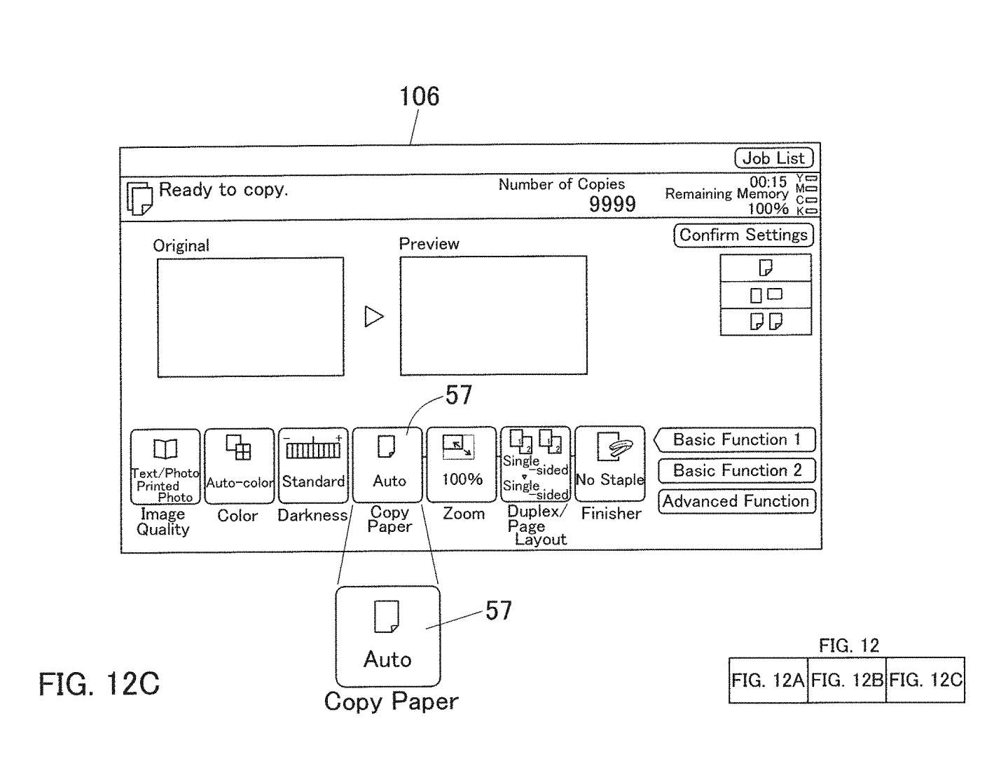

FIG. 12A, FIG. 12B, and FIG. 12C are views for reference in describing how the MFP 1 synchronizes an operation screen on the display 106 with that of the terminal apparatus 7. FIG. 12A and FIG. 12B illustrate an operation screen on the terminal apparatus 7 before and after the refreshing of the on-screen information. These operation screens are identical with those illustrated in FIG. 11A and FIG. 11B.

FIG. 12C illustrates an operation screen after the refreshing of the on-screen information. In this operation screen, a paper setting button 57 has the text string “Copy Paper” corresponding to the spoken keyword input by the user, instead of the text string “Paper”.

### Sixth Embodiment

In this embodiment, when a text string corresponding to the keyword cannot fit in a designated area of the operation screen, the MFP 1 is configured to optimize the layout of objects to fit it in the designated area.

A text string corresponding to the keyword does not always have the same length or font size as a text string related to the setting. The text string can be broken in lines, but sometimes a function setting button, for example, is not spacious enough to fit it in.

In this case, the MFP 1 expands the function setting button to fit the text string in as long as it does not cause a conflict between function setting buttons. If it causes such a conflict but displacing the other function setting buttons can avoid the conflict, the MFP 1 displaces the other function setting buttons and expands the function setting button to fit the text string in. If it causes such a conflict and displacing the other function setting buttons cannot avoid the conflict, the MFP 1 decreases the font size to fit the text string in the function setting button.

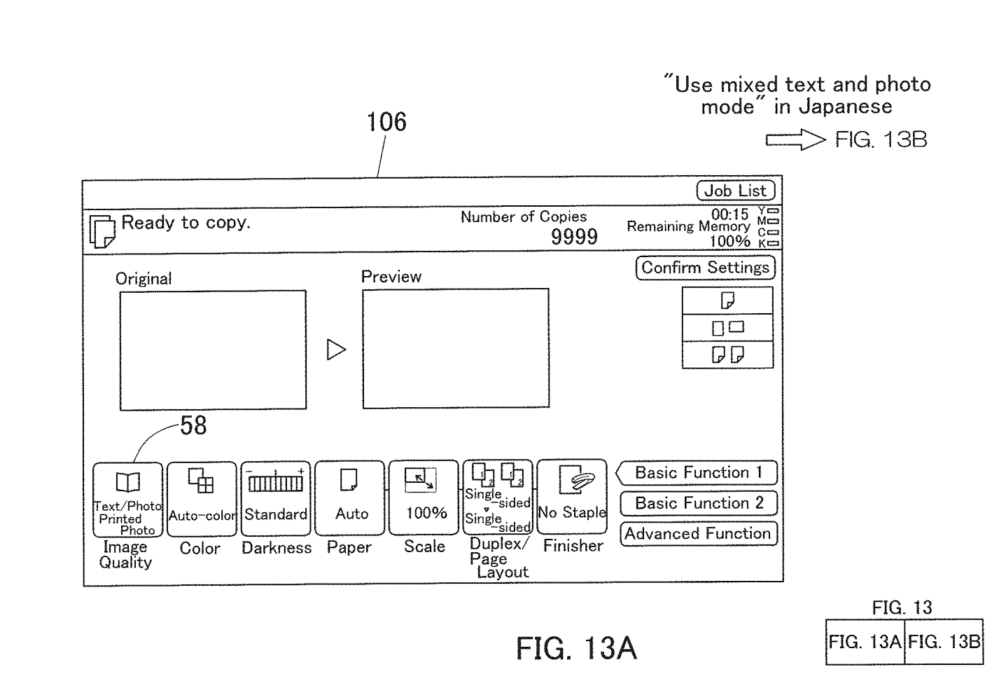

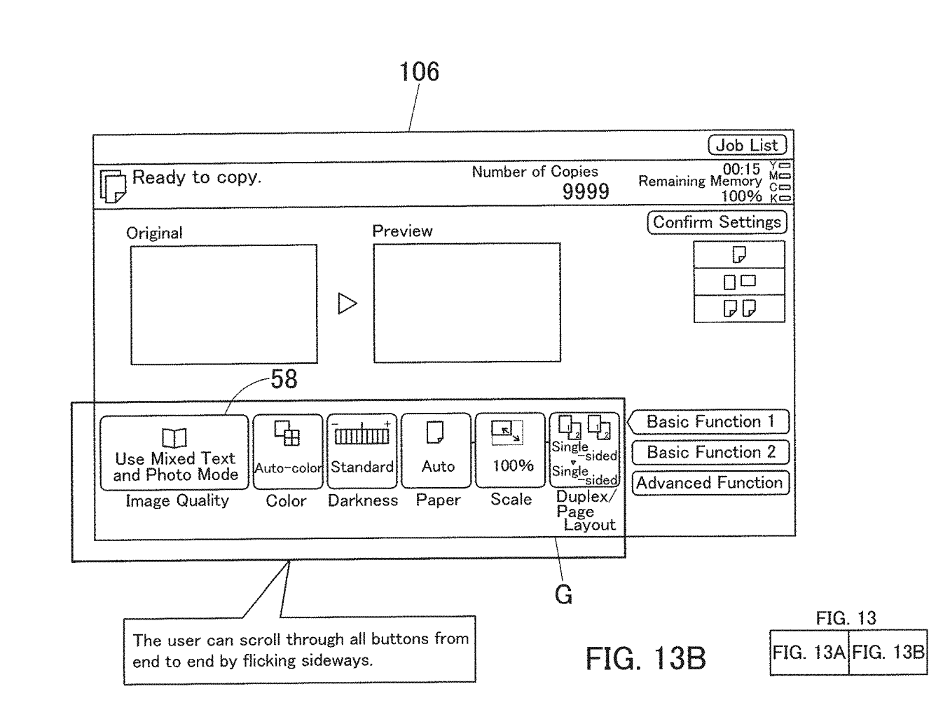

FIG. 13A and FIG. 13B illustrate how the MFP 1 optimizes the layout of objects. FIG. 13A illustrates an operation screen in which an image quality setting button 58 has a text string “Text/Photo; Photoprint”. While this operation screen is displayed on the display 106 of the MFP 1, the user inputs a speech as “use mixed text and photo mode”. Then, a text string related to the image quality setting button 58 is supposed to be changed to “Mixed Text and Photo; Photo Only” corresponding to the keyword.

However, the text string corresponding to the keyword is longer than the current text string. They can be broken in lines but the designated area is not spacious enough to fit them in.

In order to fit the full text string in it, the MFP 1 expands the image quality setting button 58 horizontally and optimizes the layout of the other function buttons, as illustrated in FIG. 13B. In FIG. 13B, the function setting buttons are marked by a solid line box G. The user can scroll the menu area by flicking sideways. The MFP 1 makes room for the image quality setting button 58 by displacing the other function setting buttons and expands the image quality setting button 58 horizontally. The user can scroll through all the function setting buttons from end to end by flicking sideways.

As described above, when a text string corresponding to the keyword cannot fit in a designated area of the operation screen, the MFP 1 optimizes the layout of objects. With this configuration, the user always can view a full text string corresponding to the keyword.

### Seventh Embodiment

In this embodiment, the MFP 1 is configured to display a text string corresponding to the keyword along with a previous text string in the operation screen.

In the first embodiment of FIG. 5A and FIG. 5B, when the user inputs a speech as “zoom in at 1.2 times”, the MFP 1 displays “Zoom” and “1.2 times” for the scale setting button 51 by changing the text strings.

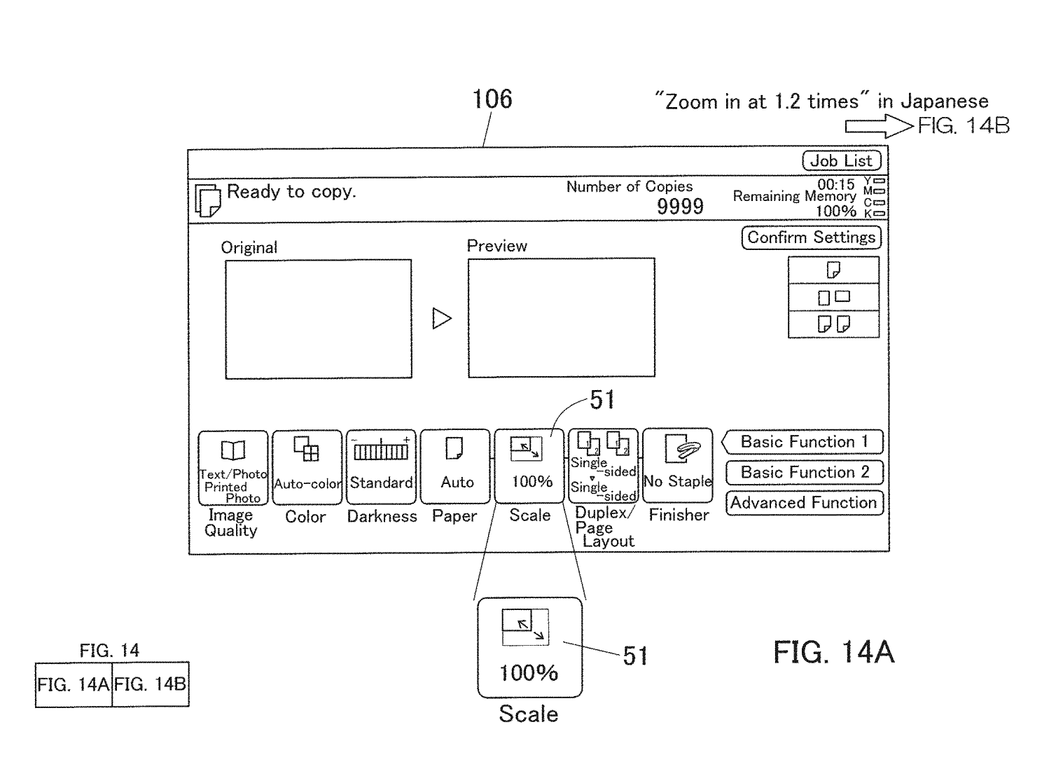

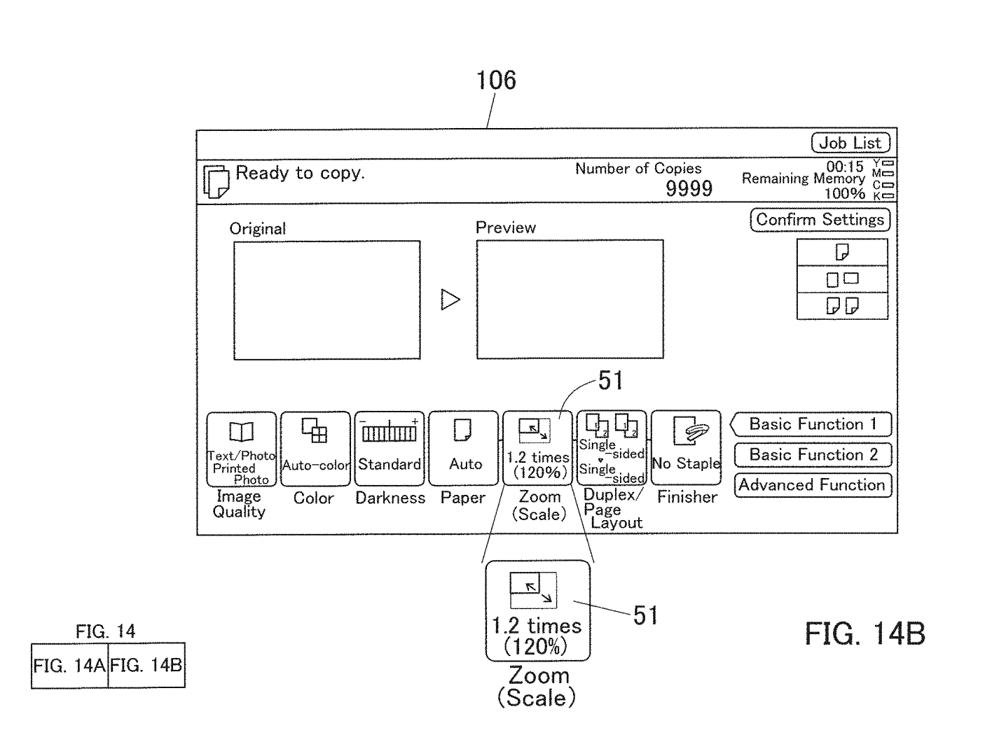

In contrast, in the seventh embodiment of FIG. 14B, the MFP 1 displays “Zoom” and “1.2 times” for the scale setting button 51 by changing the text strings, and also displays the previous text strings as illustrated in FIG. 14A, “Scale” and “120%”.

As described above, the MFP 1 displays a text string corresponding to the keyword along with a previous text string in the operation screen. With this configuration, the user can match the previous text string to the keyword.

[Flowchart]

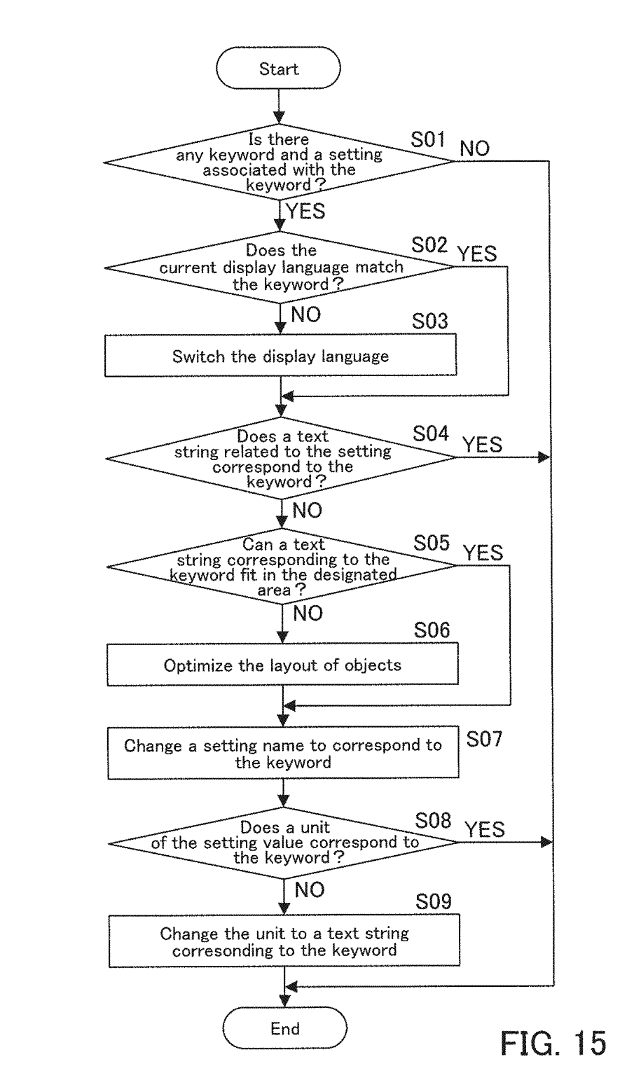

FIG. 15 is a flowchart representing operations of the MFP 1, which starts upon receiving information of a keyword and a setting associated with the keyword, from the server 2. These operations are executed by the CPU 101 of the MFP 1 in accordance with an operation program stored on a recording medium such as the ROM 103.

In Step S01, it is judged whether or not the received information includes a keyword and a setting associated with the keyword. If it does not include them (NO in Step S01), the routine terminates since there is no need to change on-screen information. If it includes them (YES in Step S01), it is then judged in Step S02 whether or not the current display language matches the keyword. If it does not match the keyword (NO in Step S02), it is switched to match the keyword in Step S03. Then the routine proceeds to Step S04. Since the display language is switched, the on-screen information is displayed in a matched language. If it matches the keyword (YES in Step S02), the routine proceeds directly to Step S04.

In Step S04, it is judged whether or not a text string related to the setting in the operation screen corresponds to the keyword. If the text string corresponds to the keyword (YES in Step S04), the routine terminates since there is no need to change on-screen information. If the text string does not correspond to the keyword (NO in Step S04), it is then judged in Step S05 whether or not a text string corresponding to the keyword can fit in the designated area. If it cannot fit in the designated area (NO in Step 505), the layout of objects is optimized in Step S06. Then the routine proceeds to Step S07. If it can fit in the designated area (YES in Step 505), the routine proceeds directly to Step S07.

In Step S07, the setting name is changed to correspond to the keyword. In Step S08, it is judged whether or not a unit of the setting value in the operation screen corresponds to the keyword. If it corresponds to the keyword (YES in Step S08), the routine terminates since there is no need to change on-screen information. If it does not correspond to the keyword (NO in Step S08), the unit is changed to correspond to the keyword in Step S09. Also, in this step, the value related to the function in the operation screen is converted accordingly.

While some embodiments of the present invention have been described in detail herein it should be understood that the present invention is not limited to these embodiments. For example, in the above-described embodiments, the server 2 performs: receiving a user speech input or a user text input; converting it to text from; retrieving a keyword from the text data; searching out a setting associated with the keyword; and transferring information of the keyword and the setting to the MFP 1 or the terminal apparatus 7 having a display for displaying operation screens. The MFP 1 or the terminal apparatus 7 may perform at least one of the following operations: converting the input to text form; retrieving a keyword from the text data; and searching out a setting associated with the keyword.

Furthermore, the speech input device 3 and the text input device 6 may be provided in the MFP 1 or the terminal apparatus 7. In this case, the user can input a speech or text to the MFP 1 or the terminal apparatus 7.

Although one or more embodiments of the present invention have been described and illustrated in detail, the disclosed embodiments are made for purposes of illustration and example only and not limitation. The scope of the present invention should be interpreted by terms of the appended claims.

What is claimed is:

1. An operation screen display device comprising a display, wherein a keyword is retrieved from a user input and a setting of an operation condition of a job is searched out by the keyword, the setting of the operation condition of the job being associated with the keyword, the operation screen display device further comprising a processor that performs:
judging whether or not an on-screen information piece related to the setting in an operation screen displayed on the display corresponds to the keyword; and
changing the on-screen information piece related to the setting in the operation screen to an information piece corresponding to the keyword if the on-screen information piece related to the setting in the operation screen does not correspond to the keyword.

2. The operation screen display device according to claim 1, wherein:
the on-screen information pieces related to the setting in the operation screen are at least one of a setting name, a setting value, a unit, and a language; and
the processor judges whether or not at least one of the setting name, the setting value, the unit, and the language corresponds to the keyword.

3. The operation screen display device according to claim 1, wherein as well as the on-screen information piece related to the setting in the operation screen, the processor also changes at least one of:
another on-screen information piece related to the same setting;
another on-screen information piece related to the same unit; and
the language of the display.

4. The operation screen display device according to claim 1, wherein the processor of the operation screen display device or an external apparatus performs searching for the setting by the keyword.

5. The operation screen display device according to claim 1, wherein the user input is a user speech input or a user text input and the keyword is retrieved from the user speech input or the user text input.

6. The operation screen display device according to claim 1, wherein the user text input is retrieved from a search box on a help screen displayed on a text input device.

7. The operation screen display device according to claim 5, wherein the retrieval of the keyword is performed by the processor of the operation screen display device or by an external apparatus.

8. The operation screen display device according to claim 1, wherein:
the operation screen serves for configuring the setting of the operation condition of the job to be executed by an image processing apparatus; and
after changing the on-screen information piece related to the setting in the operation screen to an information piece corresponding to the keyword, the processor further transfers changes to the image processing apparatus.

9. The operation screen display device according to claim 1, wherein, when an information piece corresponding to the keyword cannot fit in a designated area of the operation screen, the processor further optimizes the layout of objects in the operation screen.

10. The operation screen display device according to claim 1, wherein the processor displays an information piece corresponding to the keyword along with the previous on-screen information piece in the operation screen.

11. The image processing apparatus comprising the operation screen display device according to claim 1.

12. Anon-transitory computer-readable recording medium storing a program for execution by a computer of an operation screen display device comprising a display, wherein a keyword is retrieved from a user input and a setting of an operation condition of a job is searched out by the keyword, the setting of the operation condition of the job being associated with the keyword, the program to make the computer execute:
judging whether or not an on-screen information piece related to the setting in an operation screen displayed on the display corresponds to the keyword; and
changing the on-screen information piece related to the setting in the operation screen to an information piece corresponding to the keyword if the on-screen information piece related to the setting in the operation screen does not correspond to the keyword.
